(19) United States
(12) Patent Application Publication
(10) Pub. No.: US 2025/0245530 A1
(43) Pub. Date: Jul. 31, 2025

(54) ADAPTIVE LENGTH SPECULATIVE DECODING IN AUTOREGRESSIVE GENERATIVE ARTIFICIAL INTELLIGENCE MODELS

(71) Applicant: QUALCOMM Incorporated, San Diego, CA (US)

(72) Inventors: Raghavv GOEL, San Diego, CA (US); Mingu LEE, San Diego, CA (US); Mukul GAGRANI, Milpitas, CA (US); Wonseok JEON, San Diego, CA (US); Christopher LOTT, San Diego, CA (US); Faisal Maen Tawfiq ZAGHLOUL, Providence, RI (US); Maksim KRASNYANSKIY, San Diego, CA (US)

(21) Appl. No.: 18/423,840

(22) Filed: Jan. 26, 2024

(51) Int. Cl. G06N 5/04

(52) U.S. Cl. CPC G06N 5/04

(57) ABSTRACT

Certain aspects of the present disclosure provide techniques and apparatus for generating a response to a query input in a generative artificial intelligence model using variable draft length. An example method generally includes determining (e.g., measuring or accessing) one or more operational properties of a device on which inferencing operations using a machine learning model are performed. A first draft set of tokens is generated using the machine learning model. A number of tokens included in the first draft set of tokens is based on the one or more operational properties of the device and a defined scheduling function for the machine learning model. The first draft set of tokens are output for verification.

### INTRODUCTION

Aspects of the present disclosure relate to generative artificial intelligence models, and more specifically to speculative decoding in generative artificial intelligence models.

Generative artificial intelligence models can be used in various environments in order to generate a response to an input prompt (also referred to as a query or an input). For example, generative artificial intelligence models can be used in chatbot applications in which large language models (LLMs) are used to generate an answer, or at least a response, to an input prompt. Other examples in which generative artificial intelligence models can be used include a latent diffusion model, in which a model generates an image from an input text description of the content of the desired image, decision transformers, in which future actions are predicted based on sequences of prior actions within a given environment, or the like.

Generally, generating a response to a query using generative artificial intelligence models may be computationally expensive. For example, in a chatbot deployment in which a large language model is used to generate a response to a query formatted as a text query, a response to the query may be generated using a pass through the large language model for each token (e.g., a word or part of a word) generated as part of the response. The output of each pass may be a probability distribution on a set of tokens (e.g., words or parts of words) from which the next token (e.g., a word or part of a word) may be selected, for example, by sampling or based on maximum likelihood. Because a pass through a large language model is used to generate each word (or token(s)) in a response to a query, the computational expense may be modeled as the product of the number of words included in the response and the computational resource expense (e.g., in terms of processing power, memory bandwidth, and/or other compute resources used) of performing a pass through the large language model, which generally increases as the number of parameters within the large language model increases.

### BRIEF SUMMARY

Certain aspects of the present disclosure provide a method for generating a response to an input prompt using a generative artificial intelligence model. The method generally includes determining (e.g., measuring or otherwise accessing) one or more first operational properties of a device on which inferencing operations using a machine learning model are performed. A first draft set of tokens is generated using the machine learning model. A number of tokens included in the first draft set of tokens is based on the measured one or more first operational properties of the device and a defined scheduling function for the machine learning model. The first draft set of tokens are output for verification.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict only certain aspects of this disclosure and are therefore not to be considered limiting of the scope of this disclosure.

FIG. 1 is a diagram illustrating operations performed to generate a response to an input query using a generative artificial intelligence model and adaptive draft length based on operational parameter(s) of a device on which the generative artificial intelligence model operates, according to aspects of the present disclosure.

FIGS. 2A and 2B illustrate pseudocode for adapting the length of a draft set of tokens generated using a generative artificial intelligence model based on operational parameter(s) of a device on which the generative artificial intelligence model operates, according to aspects of the present disclosure.

FIG. 3 illustrates examples of performance metrics for constant-draft-length and adaptive-draft-length speculative decoding, according to aspects of the present disclosure.

FIG. 4 illustrates example operations for generating a response to an input prompt using a generative artificial intelligence model and adaptive draft length based on operational parameter(s) of a device on which the generative artificial intelligence model operates, according to aspects of the present disclosure.

FIG. 5 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatus, methods, processing systems, and computer-readable mediums for efficiently generating responses to input queries using generative artificial intelligence models.

Generally, generative artificial intelligence models generate a response to a query input into the model. For example, a large language model (LLM) deployed within a chatbot can generate a response to a query using multiple passes through the large language model, with each successive pass being based on the query (which may be tokenized for processing) and the tokens (e.g., words or parts of words) generated using previous passes through the large language model. Generally, these large language models may include a large number (e.g., billions, or even trillions) of weights or parameters within the model. Because of the size of these models and the operations performed on each token to predict what should be the next token generated in response to a query and the previously generated tokens, it may not be practical, or even possible, to deploy large language models on a variety of devices that have limited memory and/or processing capabilities relative to cloud compute instances on which large language models typically operate. Further, in some cases, the memory bandwidth involved in generating a response to a query provided as input into a model may prevent compute resources from being used for other tasks.

To improve the efficiency and throughput of large language models, speculative decoding techniques allow for a smaller language model, sometimes known as a draft large language model (or as a draft model or an approximation model), to execute (e.g., sequentially or in parallel) with a larger language model, sometimes known as a target large language model (or as a target model). In such a case, the draft model can generate speculatively additional tokens in sequence and probabilities used for sampling these additional tokens based on a current set of accepted tokens. The target model can generate tokens based on the tokens generated by the draft model. To generate a result, the target model can perform rejection sampling on a per-token basis to accept or reject individual tokens generated by the draft model such that the draft model and the target model have similar probability distributions.

In some aspects, the draft model may be a pruned version of the target model chosen such that the draft model and target model have similar probability distributions. In other aspects, the draft model may be a smaller version of the target model (e.g., trained on millions of tokens, instead of hundreds of millions or even billions of tokens).

Certain aspects of the present disclosure provide techniques and apparatus for generating responses to a query input into a generative artificial intelligence model, such as a large language model, using speculative decoding with adaptive draft token length parameters. According to various aspects, the draft model can generate a set of tokens as a candidate response to the query using a draft length that is determined based on a defined scheduling function for the draft model and one or more operational properties of the device on which inferencing operations are performed (e.g., an edge device, such as a user equipment (UE) or other device on which a set of tokens are speculatively generated and output to a target model for verification). Subsequent rounds of inferencing may involve adjustments to the number of tokens included in a draft set of tokens (also referred to as a token length). These adjustments may be performed to maximize, or at least increase, the rate at which tokens are generated as a response to the input query. Meanwhile, a likelihood of reaching various operational limits that may reduce the rate at which tokens are generated (e.g., reaching a temperature threshold, frequency threshold, etc., at which processor performance is degraded in an attempt to lower the processor temperature to a temperature at or below a defined maximum operational temperature) may be minimized, or at least reduced. By doing so, aspects of the present disclosure may allow for varied (e.g., increased) token generation rates, which in turn may allow for faster completion of inferencing tasks performed by generative artificial intelligence models, reduce power consumption, and minimize, or at least reduce, the likelihood that a device will enter lower-performance operating regimes during inferencing operations using generative artificial intelligence models (or other machine learning models which support variable-sized outputs).

### Speculative Decoding in Generative Artificial Intelligence Models

Generally, autoregressive token generation (e.g., in large language models) may take historical tokens as an input in order to generate an output. That is, autoregressive token generation may be represented by the expression:

$${x}_{t} ∼ p ( x \vert {x}_{0} , {x}_{1} , … , {x}_{t - 1} ) \to {x}_{t + 1} ∼ p ( x \vert {x}_{0} , {x}_{1} , … , {x}_{t - 1} , {x}_{t} )$$

where xₜ represents a sequence of tokens generated at time t, having a conditional probability p conditioned on the selection of tokens x₀ through xₜ₋₁, and xₜ₊₁ represents a sequence of tokens generated at time t+1, having a conditional probability p conditioned on the selection of tokens x₀ through xₜ. Generally, a single token may be generated each time an autoregressive model is executed, which means that N inferences may be performed to generate a sequence of N tokens. As discussed above, speculative decoding techniques can be used to accelerate token generation by using a draft model, smaller in size than the target model, that speculatively generates tokens faster than the target model, with the target model being used to verify the tokens (speculatively) generated by the draft model.

In a speculative decoding pipeline, the draft model may speculatively generate n tokens autoregressively, according to the expression:

$${x}_{t + 1}^{draft} ∼ {p}_{t}^{draft} = {p}^{draft} ( x \vert {x}_{0} , … {x}_{t} ) , {x}_{t + 2}^{draft} ∼ {p}_{t + 1}^{draft} , … , {x}_{t + n}^{draft} ∼ {p}_{t + n - 1}^{draft}$$

where t corresponds to a point in time, pₜ^{draft} corresponds to the conditional probability distribution associated with a selected token x at time t conditioned on the selection of tokens x₀ through xₜ₋₁, and xₜ^{draft} represents a token x speculatively generated at time t by the draft model.

The target model takes the generated n tokens and processes the n tokens in parallel to generate probability distributions for each of the n tokens, according to the expression:

$$[ {p}_{t}^{target} , {p}_{t + 1}^{target} , … , {p}_{t + n}^{target} ] = {[ {p}^{target} ( x \vert {x}_{0} , … {x}_{t} , {x}_{t + 1}^{draft} , … , {x}_{t + k}^{draft} ) ]}_{k = 1 , 2 , … , n}$$

where k corresponds to a token index relative to the generated n tokens and pₜ^{targett} corresponds to a probability distribution generated by the target model at time t for the tokens x generated by the draft model.

The target model can then verify the tokens generated by the draft model by comparing distributions from the draft model and target model to determine whether a token is accepted or rejected. A given token xₜ₊ₖ^{draft} may be accepted when ƒ(pₖ^{draft}, pₖ^{target})<α, for some function ƒ and some threshold α (also known as an acceptance rate). Otherwise, the token may be rejected. The final token may then be generated at the first rejection position or at the last position n based on some function g(pₖ^{graft},pₖ^{target}).

Speculative decoding, with an acceptance rate of α, may result in cost reductions relative to using a single autoregressive model to generate tokens iteratively. Inference cost savings, relative to iterative token generation, may be represented by the expression:

$${C}^{A R} = {NC}^{target} \to C = {nNC}^{draft} + \frac{N}{α + 1} {C}^{target}$$

where N corresponds to a number of tokens, CAR corresponds to a computational cost using an acceptance rate of α, C^{target} corresponds to a computational cost of generating a set of tokens using the target model, c^{draft} corresponds to a computational cost of generating a set of tokens using the draft model, C^{SD} corresponds to a computational cost of speculatively generating a set of tokens using the draft model, and n corresponds to a number of tokens generated speculatively in a single pass through an autoregressive model. Consider an example in which N=1000, C^{target}=10, C^{draft}=1, n=4, and α=3. In such an example, speculative decoding may result in a 35% reduction in computational expense relative to autoregressive iterative token generation alone.

However, speculative decoding on a per-token basis, as discussed, may impose limits on the rate at which tokens are generated, as a first token may be sampled individually by a draft model and then verified by a target model before the next token is sampled by the draft model and verified by the target model. That is, generating a response to an input prompt using per-token speculative decoding techniques may involve executing the draft model and target model for each token generated as part of a response to the input prompt, which may use significant amounts of computational resources (e.g., processor time, memory, memory bandwidth, etc.) in order to generate the response.

### Example Speculative Decoding in Generative Artificial Intelligence Models with Variable Draft Lengths

Generally, a generative artificial intelligence model that generates a response to an input query using speculative decoding techniques (discussed above) may involve a draft model that generates D draft tokens and a target model that executes over D+1 tokens. The token generation rate T_{SD} for speculative decoding techniques may generally exceed the token generation rate T_{AR} for single-token autoregressive decoding, with corresponding increases in computation cost. For example, if each token is generated with a computational cost of M, single-token autoregressive decoding may have a total computational cost of MT_{AR} per second. Meanwhile, the computational cost for the target model may be (D+1) MT_{SD} per second, which may be significantly greater than the computational cost of single-token autoregressive decoding.

While speculative decoding may allow for an increased token generation rate T_{SD}>T_{AR}, the increased computational cost involved in speculative decoding generally uses additional computational resources (e.g., additional processor cycles, memory, etc.). The use of these additional computational resources generally causes the processor(s) on which generative artificial intelligence models execute to generate a significant amount of heat. Because these processors generally are designed to operate at or below a defined maximum temperature, heat generation over time may trigger the processor to perform various actions to control the temperature of the processor. For example, various throttling techniques may be used to restrict the amount of power the processor(s) (and/or other component(s)) can draw and thus restrict the frequency at which the processor(s) (and/or other component(s)) operates (e.g., by reducing the clock speed, voltage, etc.). Such restrictions on processor frequency may in turn degrade the rate at which tokens are generated, and thus negatively impact inferencing speed for a generative artificial intelligence model.

To improve inferencing speed for a generative artificial intelligence model (e.g., measured in a number of inferences generated over a defined period of time), aspects of the present disclosure allow for the adaptation of the length of a draft set of tokens speculatively generated by a generative artificial intelligence model for verification by a target model. In some aspects, the length of the draft set of tokens may be varied based on a variety of factors, including (but not limited to) a defined scheduling function designed for a processor on which a generative artificial intelligence model executes, operational parameters of the device on which the generative artificial intelligence model executes, the acceptance rate of tokens speculatively generated by the generative artificial intelligence model, and the like.

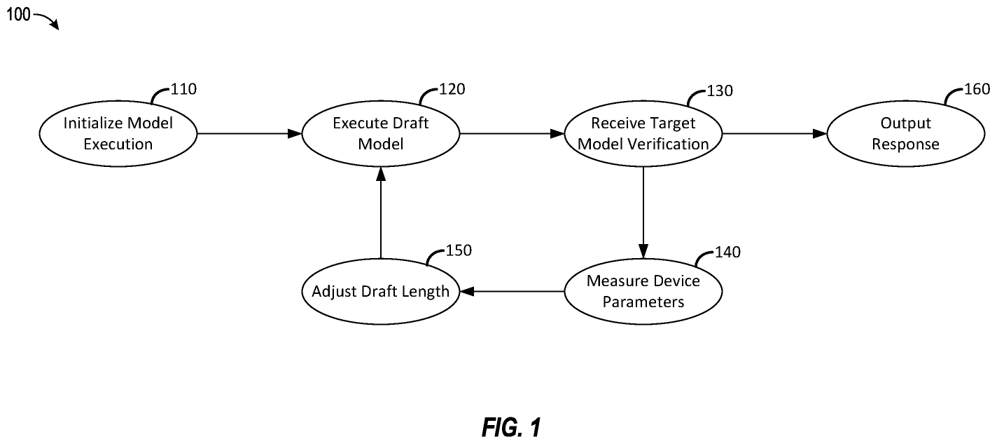

FIG. 1 is a diagram illustrating inferencing operations 100 performed to generate a response to an input query using a generative artificial intelligence model and adaptive draft length based on one or more operational parameters (e.g., measured parameters) of a device on which the generative artificial intelligence model operates, according to aspects of the present disclosure.

As illustrated, executing the inferencing operations 100 using a generative artificial intelligence model may begin at block 110, with initializing model execution. In some aspects, at block 110, an input query received from a user of the device may be input into a generative artificial intelligence model for processing according to a baseline set of parameters. These parameters may include, for example, a default (or starting) length of a draft set of tokens, a length of the draft set of tokens set according to a scheduling function designed for the processor(s) on which the generative artificial intelligence model executes, or the like. For example, the scheduling function may differ based on the computational capabilities of the processor(s) (e.g., floating-point operations per second (FLOPS), a number of processing cores, a frequency at which the processor operates, instruction retirement statistics, or the like. The scheduling function may, in some aspects, differ based on whether each of the processor core(s) on which the generative artificial intelligence model executes is a high-performance core or a high-efficiency core (e.g., in a heterogeneous architecture, such as a big.LITTLE architecture used in ARM processors), etc.). Generally, the scheduling function may be configured to assume performance degradation over time as additional operations are performed on the processor(s) to account for heat generation or other properties that may cause the processor(s) to enter lower-performance states. Larger draft token lengths may be set for processors with more extensive processing capabilities, such as dedicated neural processing units (NPUs), processors with support for large parallel workloads (e.g., graphics processing units (GPUs) with many processing units that can each execute a portion of a workload in parallel), the ability to execute a large number of FLOPS, a higher maximum frequency, or the like. Meanwhile, smaller draft token lengths may be set for processors with less extensive processing capabilities, such as processors that may support fewer parallel workloads, processors with the ability to execute a smaller number of FLOPS, a lower maximum frequency, or the like.

After model execution is initialized, the inferencing operations 100 proceed to block 120, where the generative artificial intelligence model is executed to generate a draft set of tokens.

Generally, during an initial round of the generative artificial intelligence model generating a draft set of tokens for an input query, no previous set of draft tokens has been generated in response to the input query. In some aspects, the parameters based on which the draft set of tokens is generated may include the scheduling function and the length of the draft set of tokens set at block 110.

In some aspects, historical token acceptance rates from prior queries may further be used in determining the length of the draft set of tokens generated at block 120. For example, token acceptance rates from prior input queries having similar intents may be considered in determining the length of the draft set of tokens generated at block 120. For similar queries with a high rate of token acceptance, it may be assumed that the generative artificial intelligence model will generate tokens for the input query with a similar accuracy, and thus, the length of the draft set of tokens may remain unchanged relative to a baseline set of parameters or may even be lengthened. In another aspect, if historical token acceptance rates for similar queries meet or exceed a threshold, the length of the draft set of tokens may increase over time. Generally, the length of an initial draft set of tokens may increase and decrease over time based on historical token acceptance rates such that the length of the initial draft achieves a target level of performance.

In some aspects, the amount by which the length of the draft set of tokens is increased may be based on a threshold acceptance rate or a delta between the actual acceptance rate and the threshold acceptance rate for a given length of the draft set of tokens. For example, a smaller increase to the length of the draft set of tokens may be defined for smaller deltas between the threshold and actual acceptance rates than for larger deltas between the threshold and actual acceptance rates. As an illustrative example, consider a threshold acceptance rate of 50%. If the actual acceptance rate for a draft length of n tokens is 60%, then the length of the draft set of tokens may increase by x tokens. Meanwhile, if the actual acceptance rate for a draft length of n tokens is 70%, then the length of the draft set of tokens may increase by 2*x tokens.

If, however, the generative artificial intelligence model has historically generated draft sets of tokens with low acceptance rates for similar queries, it may be assumed that the generative artificial intelligence model will generate draft sets of tokens with similarly low acceptance rates for the input query. Thus, the length of the draft set of tokens may, in some aspects, be reduced relative to the baseline set of parameters. The amount the length of the draft set of tokens is decreased may be based on similar techniques as discussed above with respect to increasing the length of the draft set of tokens.

The draft set of tokens generated at block 120 may be output to a target model for verification, and at block 130, the generative model receives verification information for the draft set of tokens from the target model. In some aspects, the target model may be a generative artificial intelligence model that is larger (e.g., includes more parameters, is trained on a larger corpus of data, etc.) than the draft model and may be used to determine whether the draft set of tokens speculatively generated by the draft model is accurate or inaccurate. Generally, the draft model receives information identifying which tokens were accepted by the target model, such as a bitmap identifying accepted tokens based on a position in the bitmap, an index of the first rejected token in the draft set of tokens (as subsequent tokens are generally also rejected), or the like.

If the draft model has not generated a terminating token that has been verified by the target model, then the operations 100 may proceed to block 140. At block 140, various device parameters are measured or otherwise determined for use in adjusting the length of the draft set of tokens to be generated by the generative artificial intelligence model during the next round of inferencing. In some examples, the temperature of the processor(s) on which the generative artificial intelligence model is executing may be measured or otherwise determined. Additionally or alternatively, in other examples, the operating frequency of the processor(s) on which the generative artificial intelligence model is executing may be measured or otherwise determined. Additionally or alternatively, in still further examples, one or more other operational parameters that may influence the performance of the processor(s) and/or other component(s), such as operating voltages, power draw (e.g., in watts), current, or the like, may be measured or otherwise determined.

At block 150, the operations 100 proceed with adjusting the length of the draft set of tokens to be generated by the generative artificial intelligence model during the next round of inferencing. Adjustments to the length of the draft set of tokens to be generated by the generative artificial intelligence model may be performed based on the (measured) operational parameter(s) of the device on which the generative artificial intelligence model is executing, the acceptance rate of the previously generated draft set of tokens, historical acceptance rates of other sets of tokens generated by the generative artificial intelligence model for the input query and historical input queries, the scheduling function defined for the processor(s) on which the generative artificial intelligence model executes, and the like. In some aspects, as discussed, the (measured) operational parameters may include a temperature, a frequency (clock speed), or the like. If at least one of the (measured) operational parameters exceeds a threshold defined for the at least one of the operational parameters (e.g., a maximum temperature and/or a maximum frequency), the length of the draft set of tokens may be set to a defined minimum number of tokens. This defined minimum number of tokens may be, for example, selected as the minimum of a baseline value (e.g., 0 tokens) or a smaller number of tokens than the number of tokens included in the previously generated set of tokens.

If at least one of the (measured) operational parameters does not exceed a threshold, the processor(s) on which the device executes may not be at risk of entering a limited performance regime (e.g., a low-power, low-frequency mode) that can degrade the rate at which inferences are generated using the generative artificial intelligence model. Thus, the number of tokens to be included in the next draft set of tokens generated by the generative artificial intelligence model may be set based, at least in part, on a historical acceptance rate for tokens generated by the generative artificial intelligence model. In some aspects, the acceptance rate may be the acceptance rate of the most recently generated set of tokens generated by the generative artificial intelligence model. In some aspects, the acceptance rate may be a time-weighted acceptance rate, such as an acceptance rate computed based on an exponential moving average, to allow for additional data to be considered in determining the accuracy of sets of tokens generated using the generative artificial intelligence model.

If the acceptance rate calculated after the current token generation iteration exceeds the acceptance rate calculated after a previous current token generation by a threshold amount, it may be determined that the generative artificial intelligence model is sufficiently accurate and that performance increases (e.g., measured in the number of tokens generated by the generative artificial intelligence model over a defined period of time) may be realized by increasing the number of tokens generated during the next iteration of token generation using the generative artificial intelligence model. If, however, the acceptance rate calculated after the current token generation iteration falls below the acceptance rate calculated after a previous current token generation by a threshold amount, it may be determined that the generative artificial intelligence model is not sufficiently accurate, and thus that the generative artificial intelligence model should generate fewer tokens during the next token generation iteration.

The adjusted token length may be provided to the generative artificial intelligence model, and the operations 100 may return to block 120 for generation of a new draft set of tokens. The loop including blocks 120, 130, 140, and 150 may continue until the generative artificial intelligence model includes a terminating token in the draft set of tokens and receives an indication that the target model has accepted (verified) the terminating token. Once the terminating token is received (e.g., included in a verified set of tokens sent to the draft model by a target model), the operations 100 may proceed from block 130 to block 160, at which the tokens speculatively generated by the generative artificial intelligence model and accepted by the target model, are output as a response to the input query.

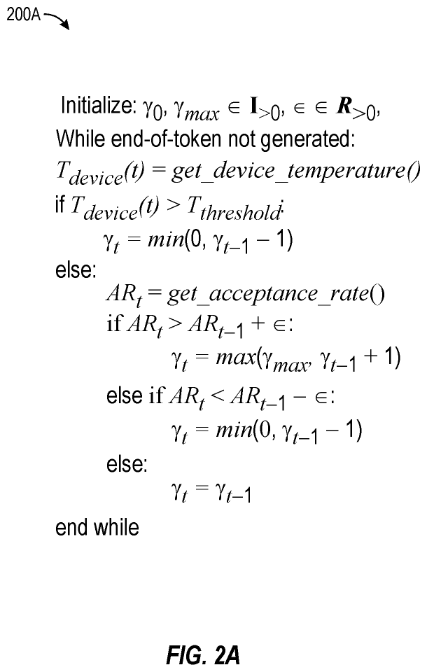

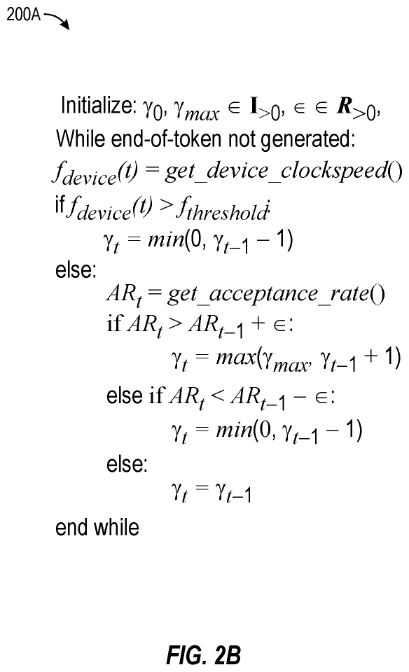

FIGS. 2A and 2B illustrate pseudocode for adapting the length of a draft set of tokens generated using a generative artificial intelligence model based on one or more (measured) operational parameters of a device on which the generative artificial intelligence model operates, according to aspects of the present disclosure.

The pseudocode 200A illustrated in FIG. 2A illustrates the use of a (measured) processor (or other component) temperature and a temperature threshold in determining the length of a draft set of tokens during a subsequent iteration of token generation operations using a generative artificial intelligence model.

As illustrated, token generation operations may be initiated with a baseline draft length γ₀, a maximum draft length γₘₐₓ∈I>0, where I represents an integer and a threshold acceptance rate divergence ϵ∈R>0, where R represents a real number. While token generation operations are being performed, a processor temperature (or other device temperature) T_{device} may be measured or otherwise determined. If the (measured) processor temperature T_{device} at time t exceeds a defined threshold T_{threshold}, which may correspond to a maximum operational temperature or a maximum temperature before processor performance is throttled, then the draft length at time t may be set according to the expression:

$${γ}_{t} = min ( 0 , {γ}_{t - 1} - 1 )$$

That is, the draft length at time t may be set to the minimum of 0 or the draft length at time t−1, less one. Generally, because a model may not be able to generate a negative number of tokens, this expression may cause the number of tokens generated by the generative artificial intelligence model to equal 0, effectuating a pause in inferencing operations until the (measured) processor temperature (or other device temperature) T_{device} falls below the threshold temperature T_{threshold}. In some aspects, however, the minimum number of tokens may be set to a positive number to allow for some (relatively small) number of tokens to be generated even while the processor temperature (or other device temperature) exceeds the temperature threshold T_{threshold}.

If, however, the (measured) processor temperature (or other device temperature) T_{device} is less than or equal to the threshold temperature T_{threshold}, the acceptance rate at time t and the prior acceptance rate at time t−1 may be used to determine whether to vary the draft length, and if so, in what direction to vary the draft length. If the acceptance rate ARₜ at time t has improved by more than the threshold divergence ϵ over the acceptance rate ARₜ₋₁ at time t−1, then the draft length may be increased. In some aspects, the draft length at time t may increase according to the expression:

$${γ}_{t} = max ( {γ}_{max} , {γ}_{t - 1} + 1 )$$

That is, the draft length γₜ at time t may be increased relative to the previous draft length unless γₜ₋₁=γₘₐₓ, as the number of tokens included in a draft set of tokens may not exceed a defined maximum. In other aspects, the draft length at time t may increase according to other expressions and/or other values (e.g., other than by 1).

If the acceptance rate ARₜ has decreased by more than the threshold ϵ relative to the prior acceptance rate ARₜ₋₁, then it may be determined that the generative model is wasting resources generating tokens that are unlikely to be accepted by the target model. Thus, to conserve computing resources and reduce the workload on the processor(s) (and corresponding heat generation from executing as many token generation operations within a given time period), the draft length may be decreased. In some aspects, the draft length at time t may decrease according to the expression:

$${γ}_{t} = max ( 0 , {γ}_{t - 1} - 1 )$$

That is, the draft length γₜ at time t may be decreased relative to the draft length at time t−1. In other aspects, the draft length at time t may decrease according to other expressions and/or other values (e.g., other than by 1). In some aspects, the draft length may be decreased up to a minimum number of tokens; for example, regardless of the historical (time-weighted) acceptance rate, the draft length γₜ at time t may allow for the generation of a defined minimum number of tokens (e.g., 1 token) so that a response to an input query may continue to be generated.

Finally, if the acceptance rate ARₜ has not diverged from the prior acceptance rate ARₜ₋₁ by more than the threshold E, the draft length γₜ at time t may remain the same as the draft length γₜ₋₁ at time t−1.

The pseudocode 200B illustrated in FIG. 2B uses measurements (or other determinations) of processor frequency ƒ_{device} (also referred to as clock speed) and a threshold processor frequency ƒ_{threshold} in order to determine whether to adjust the draft length in order to avoid entering into a lower-performance operating regime for the processor. Otherwise, determinations of the draft length at time t, relative to the draft length at time t−1, may remain the same as that illustrated in the pseudocode 200A illustrated in FIG. 2A.

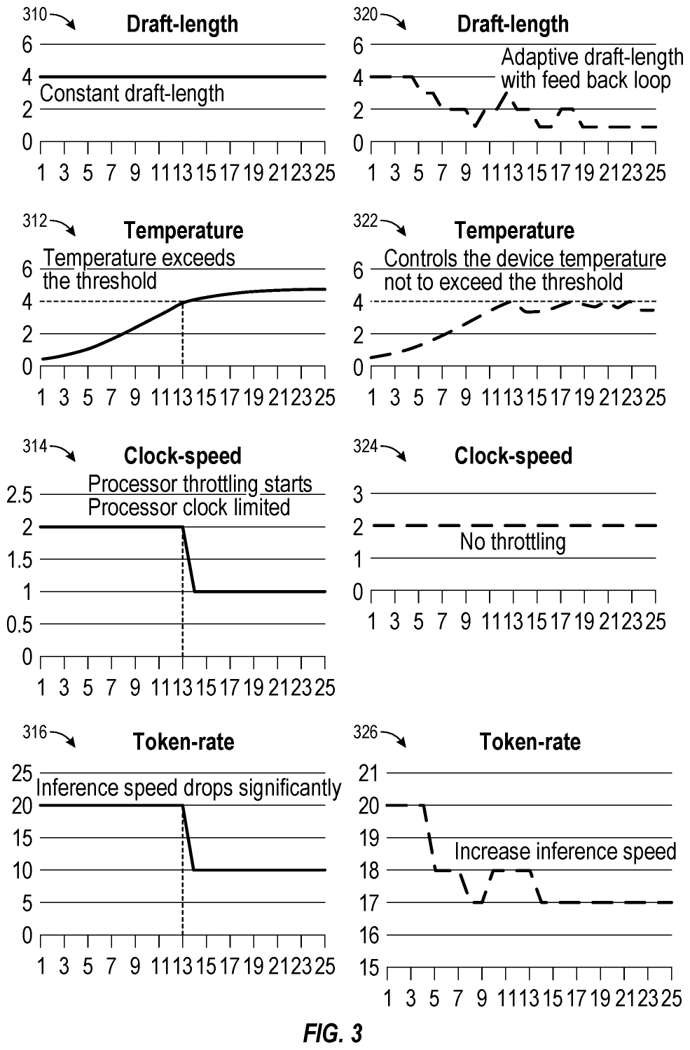

FIG. 3 illustrates examples of performance metrics for constant-draft-length and adaptive-draft-length speculative decoding for comparison, according to aspects of the present disclosure.

As illustrated, graphs 312, 314, and 316 illustrate various performance and operational parameter measurements (or other determinations) for a constant draft length illustrated in draft-length graph 310 of four tokens in each iteration of a draft set of tokens generated by a generative artificial intelligence model. Meanwhile, graphs 322, 324, and 326 illustrate various performance and operational parameter measurements (or other determinations) for a variable draft length illustrated in draft-length graph 320. The number of tokens included in each iteration of a draft set of tokens generated by the generative artificial intelligence model may be varied based on operational parameter measurements (or other determinations) and historical acceptance rate information, as discussed above.

As illustrated in the graph 312, using a constant draft length, the (measured) processor temperature may eventually exceed a threshold temperature (e.g., at the thirteenth draft token set iteration stage). Because the (measured) processor temperature exceeds the threshold temperature, the processor may be throttled from a high clock speed to a low clock speed, as illustrated in the graph 314. The result of throttling the processor from the high clock speed to the low clock speed, as illustrated, may be a significant decrease in the token generation rate for the generative artificial intelligence model: in this example, a fifty percent decrease in the token generation rate, from 20 tokens per second to 10 tokens per second.

However, using a variable draft length as illustrated in the graph 320, the (measured) temperature of the processor as depicted in the temperature graph 322 may remain below the throttling threshold temperature. Thus, unlike the scenario illustrated in the clock speed graph 314, in which the processor is throttled while inference operations are performed in respect of an input query, the clock speed graph 324 illustrates that no throttling is performed on the processor (because the processor temperature has not exceeded the threshold). Correspondingly, the rate at which tokens are generated may be influenced by the selection of a draft length for the next set of tokens generated by a generative artificial intelligence model executing on a device. As such, the rate at which tokens are generated may not be influenced (or may be less influenced) by the clock speed of the processor on which the generative artificial intelligence model executes. Thus, as illustrated in the token rate graph 326, the token generation rate for a generative artificial intelligence model using variable draft length may vary over time but may not fall as drastically as the token generation rate illustrated in the graph 316. Further, even as inference operations proceed over time, the token generation rate for a generative artificial intelligence model using variable draft length may remain closer to a theoretical maximum token generation rate than the token generation rate for a generative artificial intelligence model using a fixed draft length. Thus, inference operations using a generative artificial intelligence model and a variable draft length may be completed faster than inference operations using a generative artificial intelligence model and a fixed draft length.

### Example Operations for Generating Responses to Input Queries Using Generative Artificial Intelligence Models and Variable Draft Lengths

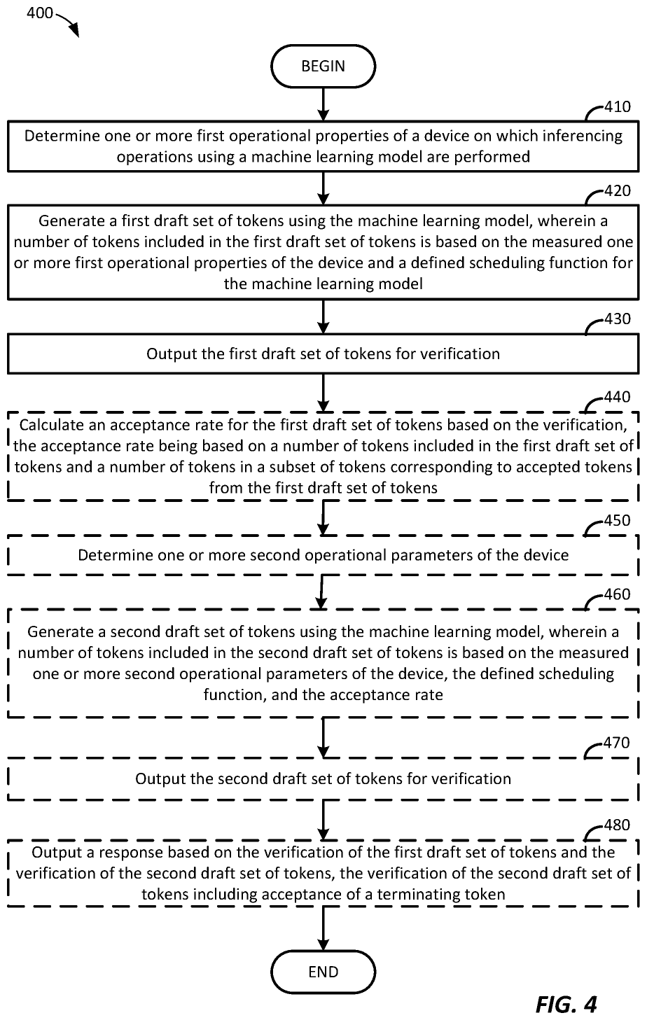

FIG. 4 illustrates example operations 400 that may be performed by a computing device to generate a response to an input prompt using a generative artificial intelligence model and adaptive draft length based on measured (or otherwise determined) operational parameters of a device on which the generative artificial intelligence model operates, according to aspects of the present disclosure. The operations 400 may be performed by a device on which at least a generative artificial intelligence model (e.g., draft model, target model, a model that can act as both the draft and target models in a self-speculative decoding pipeline, etc.) can be deployed, such as a smartphone, a tablet computer, a laptop computer, a desktop, a server, a cloud compute instance hosted in a distributed computing environment, or the like.

As illustrated, the operations 400 begin at block 410, with determining (e.g., measuring or accessing) one or more first operational properties of the device (e.g., one or more components thereof) on which inferencing operations using a machine learning model are performed.

At block 420, the operations 400 proceed with generating a first draft set of tokens using the machine learning model. Generally, the number of tokens included in the first draft set of tokens is based, at least in part, on the one or more first operational properties of the device and a defined scheduling function for the machine learning model. In some aspects, the defined scheduling function for the machine learning model may define a maximum number of tokens which can be included in a draft set of tokens and a rate at which the maximum number of tokens may change over time (e.g., decrease over time to account for various processor characteristics, such as heat generation over time).

In some aspects, the one or more first operational properties comprise a device (e.g., component(s) thereof) temperature. The number of tokens included in the first draft set of tokens may be further based on a comparison of the device temperature or device component temperature to a threshold temperature (e.g., a throttling threshold temperature).

In some aspects, the one or more first operational parameters comprise a processor frequency (or clock speed). The number of tokens included in the first draft set of tokens may further be based on a comparison of the processor frequency to a threshold frequency (e.g., a throttling threshold frequency).

In some aspects, the number of tokens included in the first draft set of tokens may be a defined minimum number of tokens for when at least one of the operational properties of the device exceeds a threshold value. In some aspects, the minimum number of tokens is determined based on a number of tokens generated during a previous token generation round using the machine learning model.

At block 430, the operations 400 proceed with outputting the first draft set of tokens for verification. The first draft set of tokens may be output to a second machine learning model (e.g., a target model) for verification. This second machine learning model may execute on the same device as the machine learning model or a different device and may be a larger model (e.g., have more parameters) than the machine learning model.

In some aspects, the operations 400 may further proceed to block 440, with calculating an acceptance rate for the first draft set of tokens based on the verification of the first draft set of tokens (e.g., generated by the second machine learning model) based on a number of tokens included in the first draft set of tokens and a number of tokens in a subset of tokens corresponding to accepted tokens from the first draft set of tokens. The number of tokens in a subset of tokens corresponding to accepted tokens from the first draft set of tokens may be determined, for example, based on information received from the target machine learning model identifying a subset of tokens from the first draft set of tokens accepted by the target machine learning model. This information may include, for example, a bitmap identifying accepted and rejected tokens, an index of the first rejected token in the first draft set of tokens, or the like.

In some aspects, the operations 400 may proceed to block 450, with determining (e.g., measuring or accessing) one or more second operational parameters of the device.

In some aspects, the operations 400 may proceed to block 460, with generating a second draft set of tokens using the machine learning model. The number of tokens included in the second draft set of tokens may be based on the one or more second operational properties of the device, the defined scheduling function, and the acceptance rate.

In some aspects, the number of tokens included in the second draft set of tokens is greater than the number of tokens included in the first draft set of tokens when the acceptance rate for the first draft set of tokens exceeds a sum of an acceptance rate for a previously generated draft set of tokens and a threshold value.

In some aspects, the number of tokens included in the second draft set of tokens is less than the number of tokens included in the first draft set of tokens when the acceptance rate for the first draft set of tokens is less than a difference between an acceptance rate for a previously generated draft set of tokens and a threshold value.

In some aspects, the number of tokens included in the second draft set of tokens equals the number of tokens included in the first draft set of tokens when the acceptance rate for the first draft set of tokens is within a threshold range (e.g., the same range) of an acceptance rate for a previously generated draft set of tokens.

In some aspects, the acceptance rate may be further calculated based on an exponential moving average of a number of accepted tokens versus a number of generated draft tokens over a plurality of iterations in which the machine learning model is executed.

In some aspects, the operations 400 may proceed to block 470, with outputting the second draft set of tokens for verification. As with the first draft set of tokens, the second draft set of tokens may be output to a second machine learning model (e.g., a target model) for verification. This second machine learning model may execute on the same device as the machine learning model or a different device and may be a larger model (e.g., have more parameters) than the machine learning model.

In some aspects, the operations 400 may proceed to block 480, with outputting a response based on the verification of the first draft set of tokens and the verification of the second draft set of tokens. Generally, verification of the second draft set of tokens includes acceptance of a terminating token in the second draft set of tokens.

### Example Processing Systems for Generating Responses to Input Queries Using Generative Artificial Intelligence Models and Variable Draft Lengths

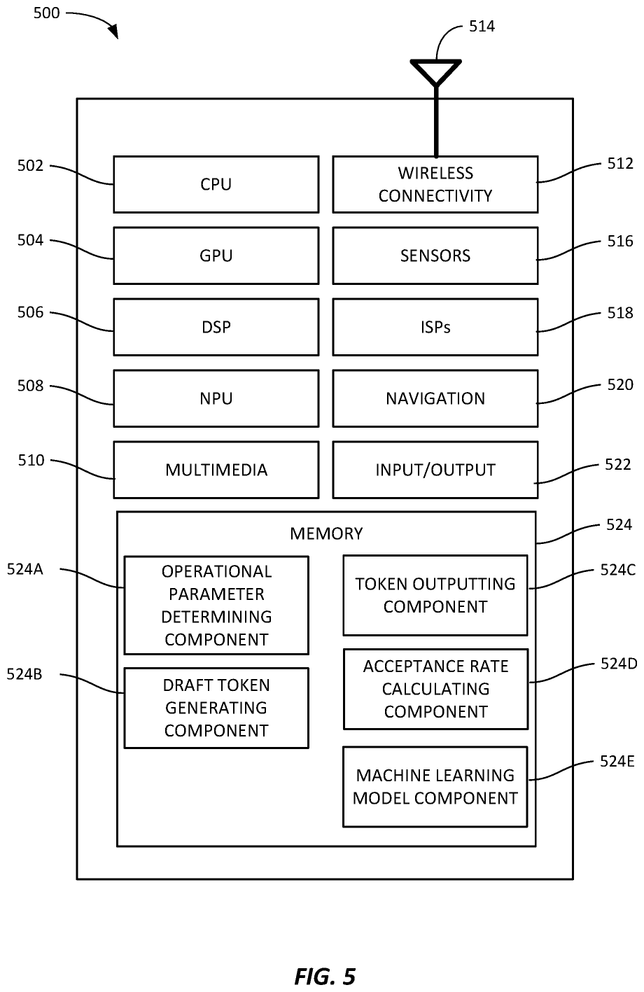

FIG. 5 depicts an example processing system 500 for generating a response to a query input into a generative artificial intelligence model based on a variable draft length, such as described herein for example with respect to FIGS. 1-4.

The processing system 500 includes a central processing unit (CPU) 502, which in some examples may be a multi-core CPU. Instructions executed at the CPU 502 may be loaded, for example, from a program memory associated with the CPU 502 or may be loaded from a memory partition (e.g., of a memory 524).

The processing system 500 also includes additional processing components tailored to specific functions, such as a graphics processing unit (GPU) 504, a digital signal processor (DSP) 506, a neural processing unit (NPU) 508, and a connectivity component 512.

An NPU, such as the NPU 508, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 508, are configured to accelerate the performance of common machine learning tasks, such as image classification, machine translation, object detection, and various other predictive models. In some examples, a plurality of NPUs may be instantiated on a single chip, such as a system on a chip (SoC), while in other examples such NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new piece through an already trained model to generate a model output (e.g., an inference).

In some implementations, the NPU 508 is a part of one or more of the CPU 502, the GPU 504, and/or the DSP 506. These may be located on a user equipment (UE) in a wireless communication system or another computing device.

In some examples, the connectivity component 512 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The connectivity component 512 may be further coupled to one or more antennas 514.

The processing system 500 may also include one or more sensor processing units 516 associated with any manner of sensor, one or more image signal processors (ISPs) 518 associated with any manner of image sensor, and/or a navigation processor 520, which may include satellite-based positioning system components (e.g., GPS or GLONASS) as well as inertial positioning system components.

The processing system 500 may also include one or more input and/or output devices 522, such as screens, touch-sensitive surfaces (including touch-sensitive displays), physical buttons, speakers, microphones, and the like.

In some examples, one or more of the processors of the processing system 500 may be based on an ARM or RISC-V instruction set.

The processing system 500 also includes the memory 524, which is representative of one or more static and/or dynamic memories, such as a dynamic random access memory, a flash-based static memory, and the like. In this example, the memory 524 includes computer-executable components, which may be executed by one or more of the aforementioned processors of the processing system 500.

In particular, in this example, the memory 524 includes an operational parameter determining component 524A, a draft token generating component 524B, a token outputting component 524C, an acceptance rate calculating component 524D, and a machine learning model component 524E. The depicted components, and others not depicted, may be configured to perform various aspects of the methods described herein.

Generally, the processing system 500 and/or components thereof may be configured to perform the methods described herein.

### Example Clauses

Implementation details of various aspects of the present disclosure are described in the following numbered clauses.

Clause 1: A processor-implemented method, comprising: determining one or more first operational properties of a device on which inferencing operations using a machine learning model are performed; generating a first draft set of tokens using the machine learning model, wherein a number of tokens included in the first draft set of tokens is based on the measured one or more operational properties of the device and a defined scheduling function for the machine learning model; and outputting the first draft set of tokens for verification.

Clause 2: The method of Clause 1, further comprising: receiving information identifying a subset of tokens from the first draft set of tokens accepted by a target machine learning model; and calculating an acceptance rate based on the number of tokens included in the first draft set of tokens and a number of tokens in the subset of tokens.

Clause 3: The method of Clause 2, further comprising: determining one or more second operational properties of the device; generating a second draft set of tokens using the machine learning model, wherein a number of tokens included in the second draft set of tokens is based on the measured one or more second operational properties of the device, the defined scheduling function, and the acceptance rate; and outputting the second draft set of tokens for verification.

Clause 4: The method of Clause 3, wherein the number of tokens included in the second draft set of tokens is greater than the number of tokens included in the first draft set of tokens when the acceptance rate for the first draft set of tokens exceeds a sum of an acceptance rate for a previously generated draft set of tokens and a threshold value.

Clause 5: The method of Clause 3 or 4, wherein the number of tokens included in the second draft set of tokens is less than the number of tokens included in the first draft set of tokens when the acceptance rate for the first draft set of tokens is less than a difference between an acceptance rate for a previously generated draft set of tokens and a threshold value.

Clause 6: The method of any of Clauses 3 through 5, wherein the number of tokens included in the second draft set of tokens equals the number of tokens included in the first draft set of tokens when the acceptance rate for the first draft set of tokens is within a threshold range of an acceptance rate for a previously generated draft set of tokens.

Clause 7: The method of any of Clauses 2 through 6, wherein the acceptance rate is further calculated based on an exponential moving average of a number of accepted tokens versus a number of generated draft tokens over a plurality of iterations in which the machine learning model is executed.

Clause 8: The method of any of Clauses 1 through 7, wherein the one or more first operational properties comprise a device temperature, and wherein generating the number of tokens included in the first draft set of tokens is further based on a comparison of the device temperature to a threshold temperature.

Clause 9: The method of any of Clauses 1 through 8, wherein the one or more first operational properties comprise a processor frequency, and wherein generating the number of tokens included in the first draft set of tokens is further based on a comparison of the processor frequency to a threshold frequency.

Clause 10: The method of any of Clauses 1 through 9, wherein the number of tokens comprises a defined minimum number of tokens for when at least one of the one or more operational properties of the device exceeds a threshold value.

Clause 11: The method of Clause 10, wherein the minimum number of tokens is determined based on a number of tokens generated during a previous token generation round using the machine learning model.

Clause 12: A processing system, comprising: at least one memory having executable instructions stored thereon; and one or more processors coupled to the at least one memory and configured to execute the executable instructions to cause the processing system to perform the operations of any of Clauses 1 through 11.

Clause 13: A processing system, comprising means for performing the operations of any of Clauses 1 through 11.

Clause 14: A non-transitory computer-readable medium having executable instructions stored thereon which, when executed by one or more processors, perform the operations of any of Clauses 1 through 11.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system, comprising:
at least one memory having executable instructions stored thereon; and
one or more processors coupled to the at least one memory and configured to execute the executable instructions to cause the processing system to:
determine one or more first operational properties of a device on which inferencing operations using a machine learning model are performed;
generate a first draft set of tokens using the machine learning model, wherein a number of tokens included in the first draft set of tokens is based on the one or more first operational properties of the device and a defined scheduling function for the machine learning model; and
output the first draft set of tokens for verification by a target machine learning model.

2. The processing system of claim 1, wherein the one or more processors are further configured to cause the processing system to:
receive, based on the output of the first draft set of tokens for verification by the target machine learning model, information identifying a subset of tokens from the first draft set of tokens accepted by the target machine learning model; and
calculate an acceptance rate based on the number of tokens included in the first draft set of tokens and a number of tokens in the subset of tokens.

3. The processing system of claim 2, wherein the one or more processors are further configured to cause the processing system to:
determine one or more second operational properties of the device;
generate a second draft set of tokens using the machine learning model, wherein a number of tokens included in the second draft set of tokens is based on the one or more second operational properties of the device, the defined scheduling function, and the acceptance rate; and
output the second draft set of tokens for verification by the target machine learning model.

4. The processing system of claim 3, wherein the number of tokens included in the second draft set of tokens is greater than the number of tokens included in the first draft set of tokens when the acceptance rate for the first draft set of tokens exceeds a sum of an acceptance rate for a previously generated draft set of tokens and a threshold value.

5. The processing system of claim 3, wherein the number of tokens included in the second draft set of tokens is less than the number of tokens included in the first draft set of tokens when the acceptance rate for the first draft set of tokens is less than a difference between an acceptance rate for a previously generated draft set of tokens and a threshold value.

6. The processing system of claim 3, wherein the number of tokens included in the second draft set of tokens equals the number of tokens included in the first draft set of tokens when the acceptance rate for the first draft set of tokens is within a threshold range of an acceptance rate for a previously generated draft set of tokens.

7. The processing system of claim 2, wherein the acceptance rate is further calculated based on an exponential moving average of a number of accepted tokens versus a number of generated draft tokens over a plurality of iterations in which the machine learning model is executed.

8. The processing system of claim 1, wherein the one or more first operational properties comprise a temperature of the device or a temperature of a component of the device, and wherein generating the number of tokens included in the first draft set of tokens is further based on a comparison of the temperature of the device or the component of the device to a threshold temperature.

9. The processing system of claim 1, wherein the one or more first operational properties comprise a processor frequency, and wherein generating the number of tokens included in the first draft set of tokens is further based on a comparison of the processor frequency to a threshold frequency.

10. The processing system of claim 1, wherein the number of tokens comprises a defined minimum number of tokens when at least one of the first operational properties of the device exceeds a threshold value.

11. The processing system of claim 10, wherein the minimum number of tokens is determined based on a number of tokens generated during a previous token generation round using the machine learning model.

12. A processor-implemented method, comprising:
determining one or more first operational properties of a device on which inferencing operations using a machine learning model are performed;
generating a first draft set of tokens using the machine learning model, wherein a number of tokens included in the first draft set of tokens is based on the one or more first operational properties of the device and a defined scheduling function for the machine learning model; and
outputting the first draft set of tokens for verification by a target machine learning model.

13. The method of claim 12, further comprising:
receiving, based on outputting the first draft set of tokens for verification by the target machine learning model, information identifying a subset of tokens from the first draft set of tokens accepted by the target machine learning model; and
calculating an acceptance rate based on the number of tokens included in the first draft set of tokens and a number of tokens in the subset of tokens.

14. The method of claim 13, further comprising:
determining one or more second operational properties of the device;
generating a second draft set of tokens using the machine learning model, wherein a number of tokens included in the second draft set of tokens is based on the one or more second operational properties of the device, the defined scheduling function, and the acceptance rate; and
outputting the second draft set of tokens for verification by the target machine learning model.

15. The method of claim 14, wherein the number of tokens included in the second draft set of tokens is greater than the number of tokens included in the first draft set of tokens when the acceptance rate for the first draft set of tokens exceeds a sum of an acceptance rate for a previously generated draft set of tokens and a threshold value.

16. The method of claim 14, wherein the number of tokens included in the second draft set of tokens is less than the number of tokens included in the first draft set of tokens when the acceptance rate for the first draft set of tokens is less than a difference between an acceptance rate for a previously generated draft set of tokens and a threshold value.

17. The method of claim 14, wherein the number of tokens included in the second draft set of tokens equals the number of tokens included in the first draft set of tokens when the acceptance rate for the first draft set of tokens is within a threshold range of an acceptance rate for a previously generated draft set of tokens.

18. The method of claim 13, wherein the acceptance rate is further calculated based on an exponential moving average of a number of accepted tokens versus a number of generated draft tokens over a plurality of iterations in which the machine learning model is executed.

19. The method of claim 12, wherein the one or more first operational properties comprise a temperature of the device or a temperature of a component of the device, and wherein generating the number of tokens included in the first draft set of tokens is further based on a comparison of the temperature of the device or the component of the device to a threshold temperature.

20. The method of claim 12, wherein the one or more first operational properties comprise a processor frequency, and wherein generating the number of tokens included in the first draft set of tokens is further based on a comparison of the processor frequency to a threshold frequency.

21. The method of claim 12, wherein the number of tokens comprises a defined minimum number of tokens when the at least one of the first operational properties of the device exceeds a threshold value.

22. The method of claim 21, wherein the minimum number of tokens is determined based on a number of tokens generated during a previous token generation round using the machine learning model.
